(19) United States
(12) Patent Application Publication
(10) Pub. No.: US 2007/0168442 A1
(43) Pub. Date: Jul. 19, 2007

(54) Method and apparatus for managing a system using an instant messaging personality

(76) Inventors: Nduwuisi Emuchay, Austin, TX (US); Gautham Pamu, Round Rock, TX (US)

Correspondence Address: IBM CORP (YA);C/O YEE & ASSOCIATES PC, P.O. BOX 802333, DALLAS, TX, 75380, US

(21) Appl. No.: 11/333,437

(22) Filed: Jan. 17, 2006

(51) Int. Cl. G06F 15/16

(52) U.S. Cl. 709/207

(57) ABSTRACT

A computer implemented method, apparatus, and computer usable program code to receive a message at an instant messaging interface for the management system from an instant messaging client. The message is translated by the instant messaging interface to produce a received command in a format recognized by the management system. The received command is sent for execution by the management system.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program code for executing commands in a system.

2. Description of the Related Art

The Internet is made up of computers organized in networks to handle data transfer and the conversion of messages. Transmission control protocol/Internet protocol (TCP/IP) is the collection of protocols used to transfer data between different end points on the Internet. The Internet also is connected to non TCP/IP networks through gateways that convert this type of traffic into other protocols used by those networks.

With the use of graphics based Web browsers, the World Wide Web became a commonly used environment on the Internet. The World Wide Web also is simply referred to as “the Web”. With the Web, information is formatted for presentation to a user through a markup language, such as hypertext markup language (HTML). This type of data often contains links to other Web resources identified by a universal resource locator (URL). The URL defines a communications path to specific information. This information typically takes the form of a page or Web page. All of this information is accessed through Web browsers.

With the Web, businesses have increasingly provided a presence on the Internet to increase the number of transactions in sales beyond what physical locations may provide. Further, many businesses exist only on the Web.

In managing these types of businesses or organization presences, the business processes involved in these types of systems depend on applications that include Web servers, application servers, integration middleware, and mainframe systems. Many businesses have traditional monitoring tools to manage individual resources at a high level but may lack an integrated solution to automatically monitor, analyze, and resolve end user response time problems. In response to these needs, management systems have been created to monitor and manage these types of operations. For example, IBM® Tivoli® Composite Application Manager (ITCAM) is employed to follow the path of the user transaction from end to end across a business structure. ITCAM is a product available from International Business Machines Corporation. In addition to tracking transactions within an infrastructure, these types of management systems provide businesses the information needed to identify and resolve actual and potential problems within their infrastructure.

These types of application managers, however, require a system administrator to understand the interface and steps needed to use an application manager such as IBM® Tivoli® Composite Application Manager. As a result, system administrators have an increased burden in terms of the knowledge needed to use this system in addition to all the other systems that the system administrator uses.

Therefore, it would be advantageous to have an improved computer implemented method, apparatus, and computer usable program code for interacting with an application management or monitoring system.

### SUMMARY OF THE INVENTION

The present invention provides a computer implemented method, apparatus, and computer usable program code to receive a message at an instant messaging interface for the management system from an instant messaging client. The message is translated by the instant messaging interface to produce a received command in a format recognized by the management system. The received command is sent for execution by the management system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a block diagram illustrating components used in managing a system using an instant messaging personality in which aspects of the present invention may be implemented;

FIG. 4 is a block diagram illustrating example messages and replies in which aspects of the present invention may be implemented;

FIG. 5 is a flowchart of a process for handling commands from an instant messaging client in which aspects of the present invention may be implemented;

FIG. 6 is a flowchart of a process for handling commands in which aspects of the present invention may be implemented; and

FIG. 7 is a flowchart of a process for sending a notification to a user in which the aspects of the present invention may be implemented.

### DETAILED DESCRIPTION OF THE PREFERRED EMBODIMENT

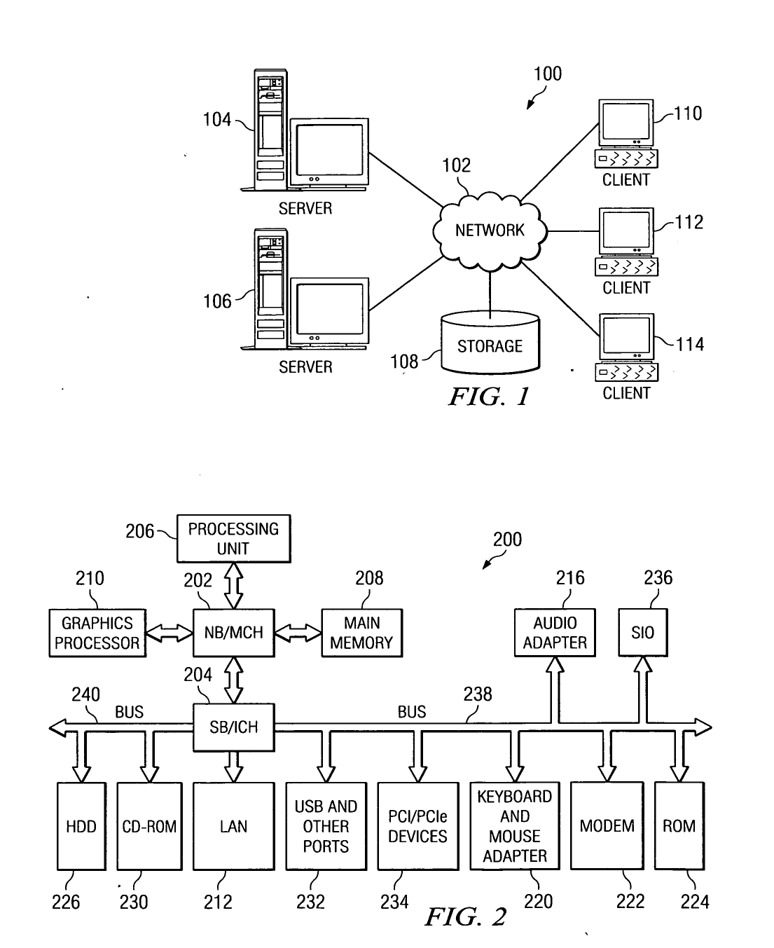

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to SB/ICH 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or LAN 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable program code for allowing a user to perform system management tasks through an instant messaging client. The aspects of the present invention allow a system administrator or other user to initiate an instant messaging conversation with the management system. In these examples, a management system is any application that is used to monitor and/or perform actions for the management of an application, data processing system, or device.

The management system includes an instant messaging interface to provide system management information about elements being monitored in a system as well as accepting commands for executing functions provided by the management system. In the illustrative examples, the management system or the administrator may initiate a “conversation” through the instant messaging system. The administrator uses a client program that is typically used for instant messaging in which conversations or messages are exchanged in real time. The management system through the instant messaging interface connects to an instant messaging server using a user ID assigned to the management system. The administrator may add the management systems user ID to a client or “buddy list”. This list is used to detect a presence of a user that is currently on line and available to chat or have a conversation. Additionally, the administrator may initiate a conversation and perform system management tasks through the instant messaging client.

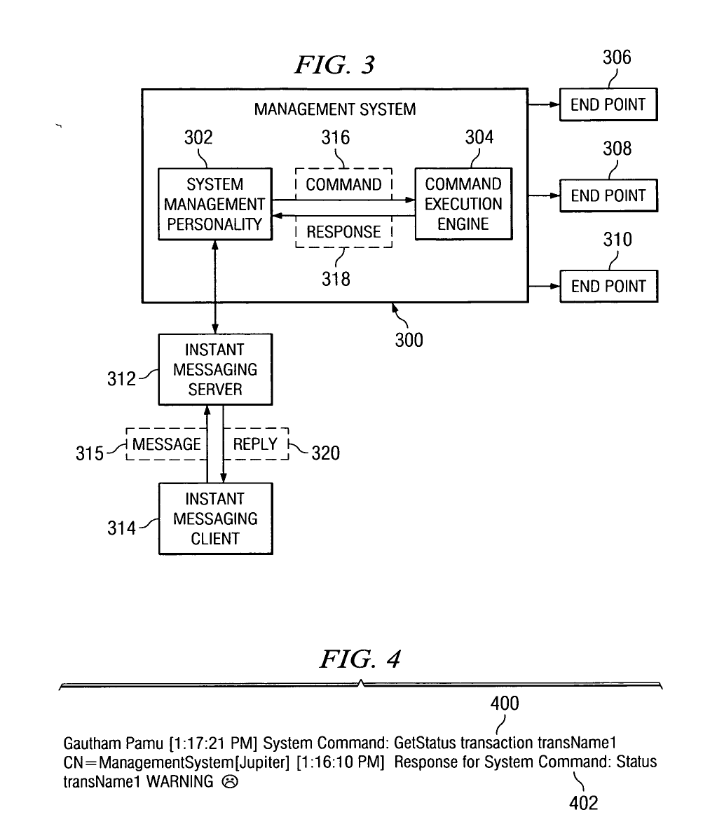

Turning now to FIG. 3, a diagram illustrating components used in managing a system using an instant messaging personality is depicted in accordance with an illustrative embodiment of the present invention. In this example, management system 300 contains system management personality 302 and command execution engine 304. Management system 300 is used to manage end points 306, 308, and 310. These end points may be, for example, hardware devices or applications. In other words, monitoring and management functions may be performed on an application executing on a data processing system. Alternatively, the management functions may be performed for the data processing system or other devices, such as a switch or a router.

System management personality 302 is employed to provide a presence for management system 300 on an instant messaging system. System management personality 302 is implemented to be an instant messaging user. In this manner, system management personality 302 is able to assume a personality on the instant messaging system. This personality may be reflective of the state of the management system. For example, if the managed systems are operating correctly, system management personality 302 may reflect this state as well as behavior in making responses. For example, an icon may be displayed with a smiley face, an upset face, or some other type of status indicator or icon to indicate the state of the system. Alternatively, system management personality 302 may be assigned a presence that behaves in some specific predictable manner depending on the particular state of management system 300. This behavior adds the “personality” to the presence of the instant messaging system in this example. Additionally, system management personality 302 maps or translates requests received from user into appropriate commands for management system 300. In some cases, system management personality 302 only translates or maps requests into commands. In other words, system management personality 302 is an instant messaging interface to the instant messaging system. The instant messaging system contains instant messaging server 312, instant messaging client 314, system management personality 302, and any other instant messaging clients or interfaces. Additionally, the instant messaging system may include additional servers depending on a particular implementation.

In this example, system management personality 302 provides an interface to exchange messages with instant messaging server 312. Management system 300 may be implemented using a data processing system, such as data processing 200 in FIG. 2. In addition, instant messaging server 312 may be implemented using the same type of hardware depending on the particular implementation. Instant messaging client 314 provides a user an interface to exchange messages with other users through instant messaging server 312. In these examples, instant messaging client 314 executes on a data processing system such as client 114 in FIG. 1, which may be implemented using data processing system 200 in FIG. 2.

In these examples, the instant messaging system used may take various forms depending on the particular implementation. For example, the instant messaging system may be implemented using IBM® Lotus® sametime® connect, which is a product of International Business Machines Corporation. Lotus® and sametime® are trademarks of International Business Machines Corporation. Of course, the aspects of the present invention may be performed on any type of instant messaging system in which real time messages may be exchanged between different clients.

In this illustrative example, system management personality 302 logs on to instant messaging server 312. The user logs on to the same system using instant messaging client 314. In these illustrative examples, the user at instant messaging client 314 and system management personality 302 only need to log onto compatible instant messaging systems. As a result, a user at instant messaging client 314 may initiate a “conversation” or session with management system 300. Additionally, in some cases, management system 300 may initiate a conversation with the user at instant messaging client 314. Such initiation may occur when certain alerts are identified for which the user is to receive notifications.

In one example, a user at instant messaging client 314 sends a command to instant messaging server 312 in message 315. This message is directed towards a name or user identifier for management system 300. In turn, instant messaging server 312 forwards message 315 to system management personality 302 in management system 300. System management personality 302 contains the processes needed to process message 315 for use in management system 300. In these examples, system management personality 302 converts the system management message into command 316 and sends this command to command execution engine 304. Command 316 also includes an identification of the user and may be based on the user ID of the user on the instant messaging client. Alternatively, message 315 may include a separate user identification of the user. Command execution engine 304 determines whether the user for command 316 has permission to execute the command. If the user has permission for the command, then the command is executed to perform some function, such as adjusting a parameter, restarting an application, or generating a status report. In these examples, the user at instant messaging client 314 is authenticated as being the user through a user ID and password system. In these illustrative examples, the management system itself includes security with support for security roles. In other words, a mapping between a particular instant messaging user and the defined user credentials is implemented. For example, system management personality 302 may contain the mapping between the instant messaging user and defined credentials for management system 300. In this manner, an instant messaging user logged in and in communication with system management personality 302 may be assigned specific access to resources and operations that may be viewed, changed, and/or manipulated based on the credentials.

After the completion of the command requested by the user, command execution engine 304 returns response 318 to system management personality 302. This response may be, for example, an acknowledgement that the command has been executed, an error message, or a report. System management personality 302 formats the response into reply 320 which is sent to instant messaging server 312 and forwarded to the user at instant messaging client 314.

Turning now to FIG. 4, a diagram illustrating example messages and replies is depicted in accordance with an illustrative embodiment of the present invention. In this example, message 400 is sent by the user to the management system. In this example, the system command is to obtain a status for a transaction name. Reply 402 is returned by the management system stating that a warning is present. This example is an example of text displayed within an instant messaging client, such as instant messaging client 314 in FIG. 3. Of course, natural language conversations could be used other than just a command formed through the instant messaging client. For example, a command may be “what is the status of policy “by book”?”. Another example of a natural language command is “what is the status of endpoint “HR system.domain.company.com”?”. Also, “what is the load on server “payroll system.domain.company.com”?” is another example. Another natural language example is “how likely are my transactions to fail given the current system load and available resources?”. These natural language commands are translated into commands recognized by the management system in these examples.

With natural language messages, the command execution engine uses simple rules in the form of regular expressions or data patterns to map the text to system management commands and perform operations, such as invoking other services to return a response to the user. This response may be converted to a natural language or other output based on the system management personality. If the management system is unable to convert a system management command, the management system returns a list of possible commands so that the user can select the appropriate questions or next steps.

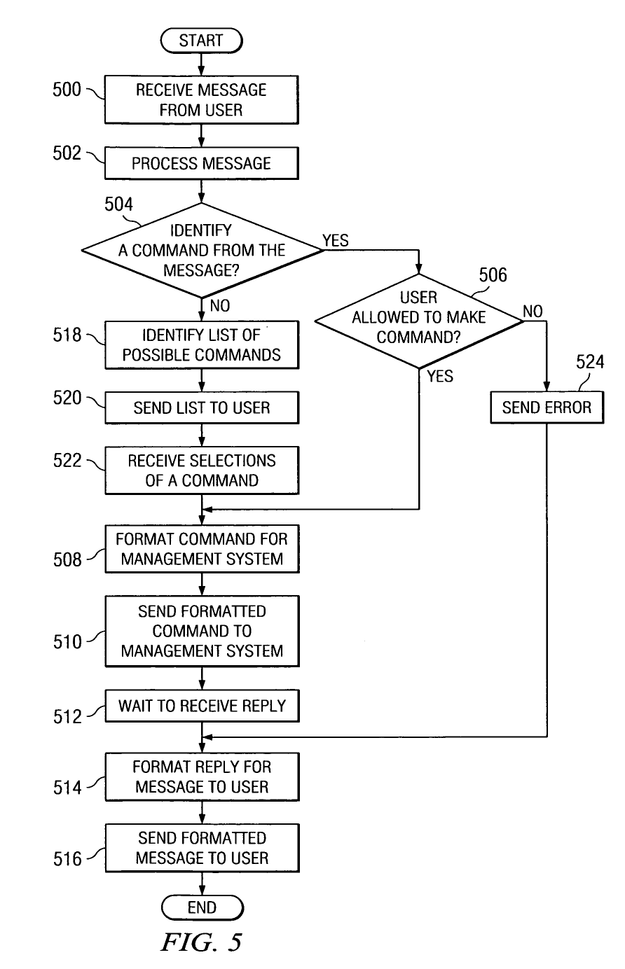

Turning now to FIG. 5, a flowchart of a process for handling commands from an instant messaging client is depicted in accordance with an illustrative embodiment of the present invention. In these examples, the processes of FIG. 5 are implemented in system management personality 302 and command execution engine 304 in FIG. 3. Of course, depending upon the particular implementation, a single component may be used to execute these steps or additional components other than those shown in FIG. 3 may be implemented.

The process begins by receiving a message from the user (step 500). Thereafter, the message is processed (step 502). The message may be processed to identify the user and the language for the command. Next, a determination is made as to whether a command can be identified from the message (step 504). If the command can be identified, a determination is then made as to whether the user is allowed to make the command specified in the message (step 506).

If the user is allowed to make the command, the process then formats the command for the management system (step 508). In step 508, the command is formatted into a form that is actually used by the management system (step 506). For example, the user can send an message such as “what is the status of policy “buy book”?”. The message is translated as “get status of policy “buy book”. The command execute engine invokes the operation/method to retrieve the status of policy. If the method returns normal, the response from the operation is translated to “status of policy “buy book” is normal.

Another example of a natural language command is “what is the status of endpoint “HR system.domain.company.com”?”. The message is translated to retrieve status/availability of managed resource. The command execution engine executes an operation to retrieve status of endpoint. If the service returns OFFLINE status, the returned message is translated to “The status of endpoint “HR system.domain.company.com” is OFFLINE”.

Thereafter, the formatted command is sent to the management system for execution (step 510). In these examples, the command is sent to a command execution engine, such as command execution engine 304 in FIG. 3. Thereafter, the process waits to receive a reply from the command sent to the management system (step 512). When a reply is received, the reply is formatted for a message to be sent to the user (step 514), and the formatted message is then sent to the user over the instant messaging system (step 516) with the process terminating thereafter.

With reference again to step 504, if the command cannot be identified from the message, then a list of possible commands is identified (step 518). Thereafter, the list is returned to the user (step 520) in the form of a reply. A selection of a command is then received (step 522). Thereafter, the process proceeds to step 508 as described above. In step 506, if the user is not allowed to make the command, an error message is returned (step 524) with the process proceeding to step 514.

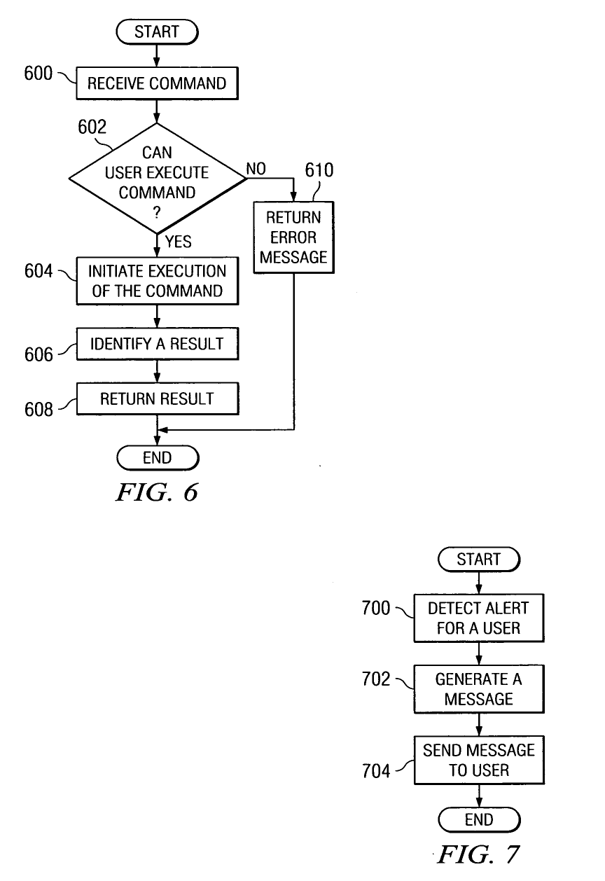

Turning now to FIG. 6, a flowchart of a process for handling commands is depicted in accordance with an illustrative embodiment of the present invention. The process illustrated in FIG. 6 may be implemented in a command execution engine, such as command execution engine 304 in FIG. 3. This particular flowchart illustrates the processing that the command execution engine performs on the command received by the system management personality.

The process begins by receiving a command (step 600). In this example, the command is received from a system management personality, such as system management personality 302 in FIG. 3. This command also includes an identification of the user. Next, a determination is made as to whether the user is allowed to execute the command received (step 602). If the user is allowed to execute the command, the process initiates execution of the command (step 604). Thereafter, a result is identified (step 606), and the result is returned (step 608) with the process terminating thereafter.

The result is returned to the system management personality and may take a number of different forms. For example, the result may be an acknowledgement that the command was successfully executed. Additionally, a report or log may be returned as the result. As another alternative, an error also may be returned as a result. With reference again to step 602, if the user cannot execute the command, the process returns an error message (step 610).

Turning now to FIG. 7, a flowchart of a process for sending a notification to a user is depicted in accordance with an illustrative embodiment of the present invention. The process illustrated in FIG. 7 may be implemented in a system management personality, such as system management personality 302 in FIG. 3. The process begins by detecting an alert for a user (step 700). In this example, the user identifier is one in which a user ID on an instant messaging system is present. A message is generated (step 702), and a message is sent to the user over the instant messaging system (step 704) with the process terminating thereafter. With this type of process, the management system may alert users to various situations that may occur in the network or within the organization of applications and/or devices being managed. These alerts may be ones set that the user desires to receive or may be critical alters, such as a failure of an application or device.

Thus, the aspects of the present invention provide a computer implemented method, apparatus, and computer usable program code for allowing a user to communicate with a management system through an instant messaging system. In this manner, users are not required to learn to use new interfaces that may be specific to a particular management system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for communicating with a management system, the computer implemented method comprising:
receiving a message at an instant messaging interface for the management system from an instant messaging client;
translating the message by the instant messaging interface to produce a received command in a format recognized by the management system; and
sending the received command for execution by the management system.

2. The computer implemented method of claim 1, wherein the management system manages at least one of a set of applications and a set of hardware devices.

3. The computer implemented method of claim 1, wherein the command is associated with a user and wherein the sending step comprises:
determining whether the user is authorized to execute the received command; and
responsive to the user being authorized to execute the command, sending the received command for execution by the management system.

4. The computer implemented method of claim 1 further comprising:
identifying a result from an execution of the received command; and
sending a result in a reply message to the instant messaging client.

5. The computer implemented method of claim 1 further comprising:
responsive to detecting an alert for a user, sending an alert message through the instant messaging interface to the user at an associated instant messaging client.

6. The computer implemented method of claim 1, wherein the received command is a request for a status report.

7. The computer implemented method of claim 1, wherein the received command is a request to restart an application.

8. The computer implemented method of claim 1, wherein the processing step is implemented in a command execution engine.

9. A computer program product comprising:
A computer usable medium having computer usable program code for communicating with a management system, the computer program product including:
computer usable program code for receiving a message at an instant messaging interface for the management system from an instant messaging client;
computer usable program code for translating the message by the instant messaging interface to produce a received command in a format recognized by the management system; and
computer usable program code for sending the received command for execution by the management system.

10. The computer program product of claim 9 wherein the management system manages at least one of a set of applications and a set of hardware devices.

11. The computer program product of claim 9, wherein the command is associated with a user and wherein the computer usable program code for sending the received command for execution by the management system comprises:
computer usable program code for determining whether the user is authorized to execute the received command; and
computer usable program code, responsive to the user being authorized to execute the command, sending the received command for execution by the management system.

12. The computer program product of claim 9 further comprising:
computer usable program code for identifying a result from an execution of the received command; and
computer usable program code for sending a result in a reply message to the instant messaging client.

13. The computer program product of claim 9 further comprising:
computer usable program code, responsive to detecting an alert for a user, for sending an alert message through the instant messaging interface to the user at an associated instant messaging client.

14. The computer program product of claim 9, wherein the received command is a request for a status report.

15. The computer program product of claim 9, wherein the received command is a request to restart an application.

16. The computer program product of claim 9, wherein the computer usable program code for processing the received command for execution in the management system is implemented in a command execution engine.

17. A data processing system comprising:
a bus;
a communications unit connected to the bus;
a memory connected to the bus, wherein the storage device includes a set of computer usable program code; and
a processor unit connected to the bus, wherein the processor unit executes the set of computer usable program code to receive a message at an instant messaging interface for the management system from an instant messaging client; translate the message by the instant messaging interface to produce a received command in a format recognized by the management system; and send the received command for execution by the management system.

18. The data processing system of claim 17, wherein the management system manages at least one of a set of applications and a set of hardware devices.

19. The data processing system of claim 17, wherein in executing the computer usable program code to process the receiving command the processor unit further executes the computer usable program code to determine whether the user is authorized to execute the received command; and sent the received command for execution by the management system.

20. The data processing system of claim 17, wherein the processor unit further executes the computer usable program code to identify a result from an execution of the received command; and send a result in a reply message to the instant messaging client.
